(19) United States
(12) Patent Application Publication
(10) Pub. No.: US 2025/0033872 A1
(43) Pub. Date: Jan. 30, 2025

(54) REFUSE BIN ASSEMBLY INCLUDING A REFUSE BIN AND AN ORGANIC WASTE RECEPTACLE, AND A METHOD OF RETROFITTING A REFUSE BIN

(71) Applicant: David M. Raba, Tujunga, CA (US)

(72) Inventor: David M. Raba, Tujunga, CA (US)

(21) Appl. No.: 18/781,315

(22) Filed: Jul. 23, 2024

Related U.S. Application Data
(60) Provisional application No. 63/515,498, filed on Jul. 25, 2023.

(51) Int. Cl. B65F 1/00; B65F 1/04; B65F 1/14; B65F 1/16

(52) U.S. Cl. CPC B65F 1/006; B65F 1/04; B65F 1/1646; B65F 2001/0086; B65F 2001/1489; B65F 2210/132

(57) ABSTRACT

A refuse bin assembly includes a refuse bin including a base, walls extending upward from the base, an interior compartment defined by the base and the walls, a mouth at an upper portion of the walls that is in communication with the interior compartment, and a lid hingedly coupled to a rear sidewall of the sidewalls. The refuse bin assembly also includes an organic waste receptacle in the interior of the refuse bin.

### CROSS-REFERENCE TO RELATED APPLICATION(S)

The present application claims priority to and the benefit of U.S. Provisional Application No. 63/515,498, filed Jul. 25, 2023, the entire content of which is incorporated herein by reference.

### BACKGROUND

### 1. Field

The present disclosure relates generally to refuse bins.

### 2. Description of the Related Art

Some jurisdictions (cities, municipalities, or states) have started mandating that organic waste, such as food scraps and leftovers, be disposed of in the “green” waste bin rather than the trash bin. That is, food waste must be recycled in the bin used for “green” waste, such as garden trimmings, lawn clippings, and leaves. For instance, Senate Bill 1383 in California mandates such disposal of organic waste. This is part of a larger effort to reduce short-lived climate pollutants (including methane) and redirect organic waste from landfills back to the soil as compost or mulch.

However, these green waste bins are not always put out for collection each week (e.g., they may only be put out every two weeks or even less frequently) because these bins typically do not fill up as quickly as the trash bin or the recycle bin. Accordingly, if food waste is disposed of in the green waste bin and the green waste bin is not placed out for pickup regularly, the food waste will sit for an extended period of time, which creates a hazardous health situation. Potential issues (especially in warm weather) include bad odors, molds, insects/cockroaches, rats/mice/vermin, and attracting other animals. This issue may be exacerbated if the food waste is placed into an empty green bin (i.e., the food waste is placed into the green bin before placing yard waste into the bin), the food waste may get stuck to the bottom and/or sides of the green bin. To prevent these issues, the green waste bin would need to be cleaned regularly, which is cumbersome and dirty and therefore unlikely to occur consistently. Moreover, washing out the green waste bin, such as with a hose in the street, may spread the organic waste around the surrounding neighborhood, which may result in potential issues (especially in warm weather), such as bad odors, molds, insects/cockroaches, rats/mice/vermin, etc.

The above information disclosed in this Background section is only for enhancement of understanding of the background of the invention and therefore it may contain information that does not constitute prior art.

### SUMMARY

The present disclosure relates to various embodiments of a refuse bin assembly. In one embodiment, the refuse bin assembly includes a refuse bin that includes a base, at least one wall extending upward from the base, an interior compartment defined by the base and the at least one wall, a mouth at an upper portion of the at least one wall that is in communication with the interior compartment, and a lid hingedly coupled to the at least one wall. The refuse bin assembly also includes an organic waste receptacle in the interior of the refuse bin.

The refuse bin may include two or more walls extending upward from the base.

The lid may be hingedly coupled to the back wall and the organic waste receptacle may be coupled to a front wall.

The organic waste receptacle may be coupled to one of two sidewalls of the refuse bin.

The organic waste receptacle may be wedge-shaped and taper from a wider upper end to a narrower lower end.

The refuse bin assembly may also include a biodegradable liner in the organic waste receptacle.

The refuse bin assembly may also include a removable insert in the organic waste receptacle.

The organic waste receptacle may include at least one drainage hole.

The organic waste receptacle may be detachable from the refuse bin.

The organic waste receptacle may be integral with the refuse bin.

An opening of the organic waste receptacle may be substantially flush with the mouth of the refuse bin.

An opening of the organic waste receptacle may be recessed below the mouth of the refuse bin.

The organic waste receptacle may be coupled to the refuse bin with fasteners.

The organic waste receptacle may be coupled to the refuse bin with an adhesive.

A rear wall of the organic waste receptacle may be substantially flat.

A rear wall of the organic waste receptacle may be convex.

The present disclosure relates to various embodiments of a method of retrofitting a refuse bin to accept organic waste. In one embodiment, the method includes securing an organic waste receptacle in an interior of the refuse bin.

Securing may include fastening the organic waste receptacle to the interior of the refuse bin with fasteners.

Securing may include adhering the organic waste receptacle to the interior of the refuse bin with an adhesive.

The method may also include installing a liner in the organic waste receptacle.

The method may also include installing an insert in the organic waste receptacle.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable method or system.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a side view of refuse bin assembly according to one embodiment of the present disclosure including a refuse bin and an organic waste receptacle showing the lid of the refuse bin in an open position and the organic waste receptacle exploded above the refuse bin prior to installation;

FIG. 2 is a side view of the refuse bin assembly of FIG. 1 showing the lid of the refuse bin in an open position and the organic waste receptacle installed inside the refuse bin (partially sectioned) but before the nuts are attached;

FIG. 2A is a side view of the refuse bin assembly of FIG. 1 showing the lid of the refuse bin in an open position and the organic waste receptacle integrally formed inside the refuse bin (partially sectioned);

FIG. 3 is partial exploded perspective view of the refuse bin assembly of FIG. 1 showing the organic waste receptacle, a portion of a wall of the refuse bin, and retaining nuts;

FIG. 3A is partial exploded perspective view of the refuse bin assembly according to one embodiment of the present disclosure showing the organic waste receptacle, a portion of a wall of the refuse bin, and adhesive;

FIG. 3B is partial exploded perspective view of the refuse bin assembly according to one embodiment of the present disclosure showing the organic waste receptacle, a portion of a wall of the refuse bin, and retaining key-type bolts and nuts;

FIG. 3C is partial exploded perspective view of the refuse bin assembly according to one embodiment of the present disclosure showing the organic waste receptacle, a portion of a wall of the refuse bin, and nuts and bolts;

FIG. 4 is partial exploded perspective view of the refuse bin assembly according to one embodiment of the present disclosure showing the organic waste receptacle, a portion of a wall of the refuse bin, nuts and bolts, and a biodegradable bag in the organic waste receptacle;

FIG. 5 is a partial exploded side view cross section of the refuse bin assembly according to one embodiment of the present disclosure showing the organic waste receptacle, a portion of a wall of the refuse bin, nuts and bolts, and a biodegradable bag in the organic waste receptacle;

FIG. 6 is a partial exploded side view cross section of the refuse bin assembly according to one embodiment of the present disclosure showing the organic waste receptacle, a portion of a wall of the refuse bin, nuts and bolts, and a biodegradable bag in the organic waste receptacle;

FIG. 7 is a partial side view cross section of the refuse bin assembly according to one embodiment of the present disclosure showing the organic waste receptacle coupled to a portion of a wall of the refuse bin with nuts and bolts, and a biodegradable bag in the organic waste receptacle;

FIG. 8 is a side view of the refuse bin assembly (partially sectioned) according to one embodiment of the present disclosure showing the refuse bin and the organic waste receptacle being tipped over to empty their contents;

FIG. 9 is a partial exploded perspective view of the refuse bin assembly according to one embodiment of the present disclosure showing the organic waste receptacle, a portion of a wall of the refuse bin, nuts and bolts, and a liner above the organic waste receptacle;

FIG. 10 is a partial exploded perspective view of the refuse bin assembly according to one embodiment of the present disclosure showing the organic waste receptacle, a portion of a wall of the refuse bin, nuts and bolts, and a liner inserted into the organic waste receptacle;

FIG. 11 is a partial exploded perspective view of the refuse bin assembly according to one embodiment of the present disclosure showing an organic waste receptacle having a double taper (double wedge shape), a portion of a wall of the refuse bin, and nuts and bolts;

FIG. 12 is a partial exploded perspective view of the refuse bin assembly according to one embodiment of the present disclosure showing an organic waste receptacle having a curved (convex) inner surface, a portion of a wall of the refuse bin, and nuts and bolts;

FIG. 13 is a partial exploded perspective view of the refuse bin assembly according to one embodiment of the present disclosure showing an organic waste receptacle having a double taper (double wedge shape) and a curved (convex) inner surface, a portion of a wall of the refuse bin, and nuts and bolts;

FIG. 14 is a partial elevation view of a refuse bin assembly according to one embodiment of the present disclosure showing three potential locations for the organic waste receptacle, on the front wall of the refuse bin or on one of the two opposing sidewalls of the refuse bin; and

FIG. 15 is a flowchart illustrating tasks of a method of retrofitting a refuse bin to accept organic waste according to one embodiment of the present disclosure.

### DETAILED DESCRIPTION

The present disclosure relates to various embodiments of a refuse bin including a separate organic waste receptacle and various methods of retrofitting a refuse bin with an organic waste receptacle configured to accept organic waste.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

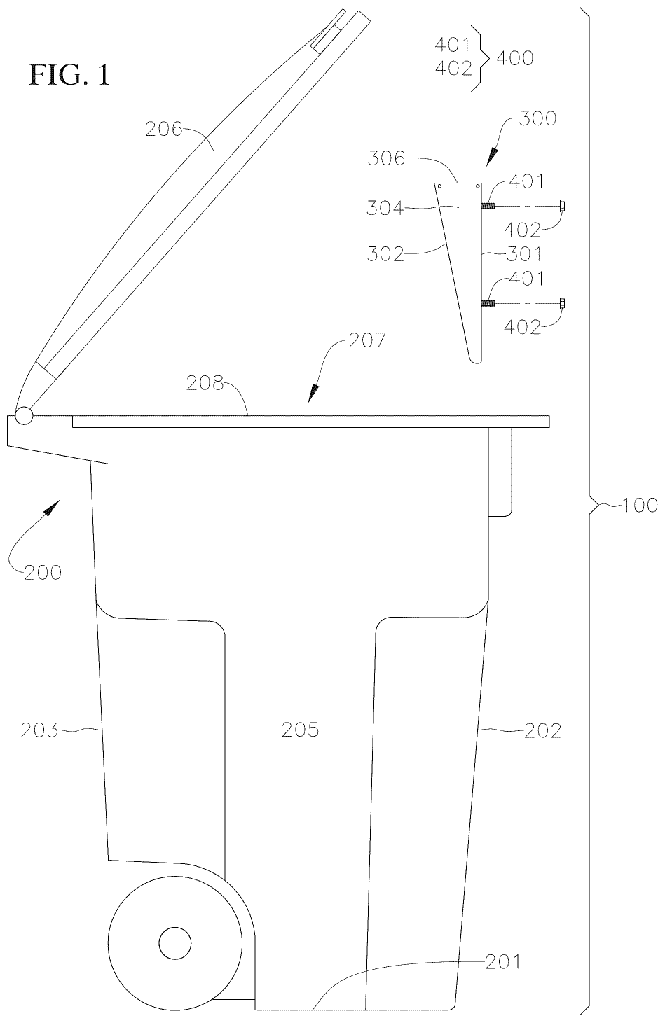

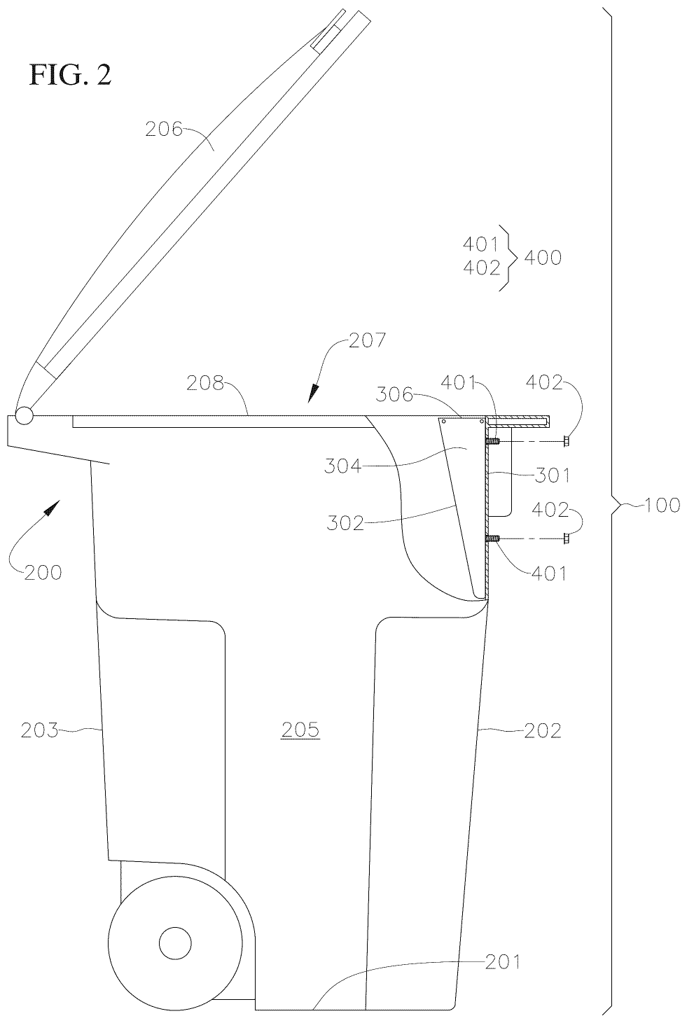

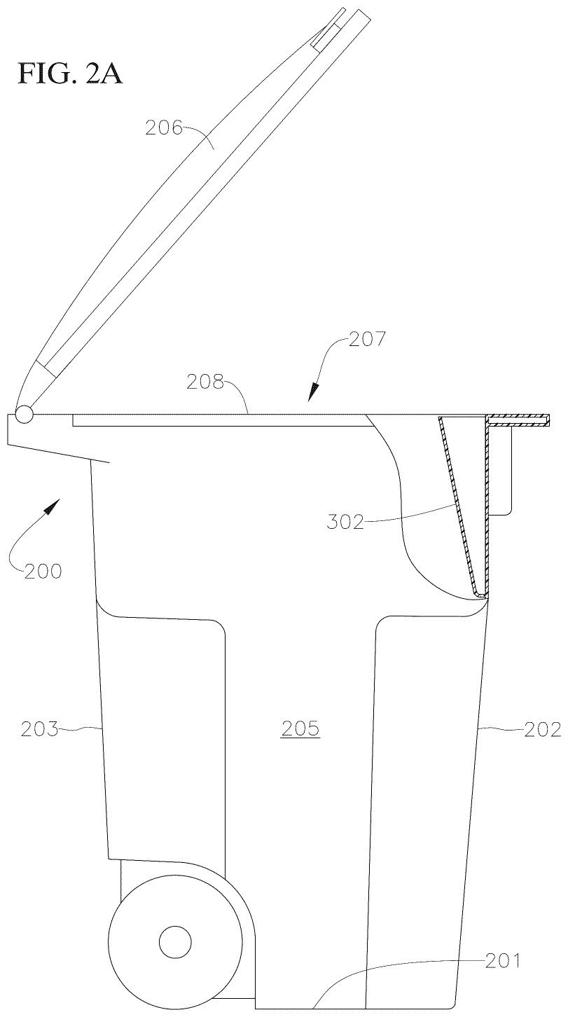

With reference now to FIGS. 1-2B, a refuse bin assembly 100 according to one embodiment of the present disclosure includes a refuse bin 200 and an organic waste receptacle 300 coupled to the refuse bin 200. In the illustrated embodiment, the refuse bin 200 includes a base 201, one or more walls (e.g., a front wall 202, a rear wall 203, and a pair of opposing sidewalls 204, 205) extending upward from the base 201, and a lid 206 hingedly coupled to the rear wall 203. Together, the base 201 and the walls 202-205 define an interior compartment 207 configured to accommodate waste, such as yard waste (e.g., leaves, garden and lawn clippings, and twigs). The refuse bin 200 includes a mouth 208 at an upper end portion of the walls 202-205. The mouth 208 is in communication with the interior compartment 207. Although in the illustrated embodiment the refuse bin 200 includes four walls, in one or more embodiments, the refuse bin 200 may include any other suitable number of walls, such as three or more walls (e.g., three or more walls arranged in a prismatic configuration), a single wall (e.g., a single cylindrical wall), or two walls.

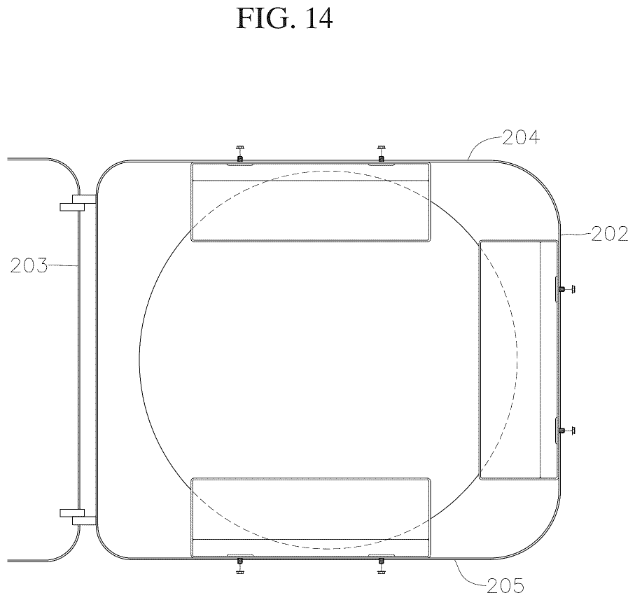

In the illustrated embodiment, the organic waste receptacle 300 is coupled to the front wall 202 of the refuse bin 200. In one or more embodiments, the organic waste receptacle 300 may be coupled to one of the sidewalls 204 or 205 of the refuse bin 200. For instance, FIG. 14 depicts three potential locations for the organic waste receptacle 300, namely, on the front wall 202, one of the sidewalls 204, and/or on the other sidewall 205.

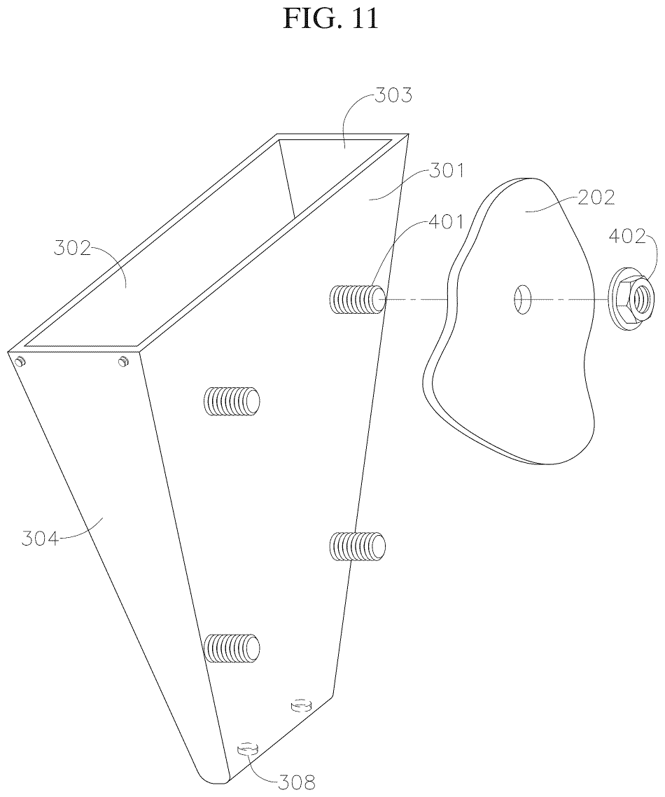

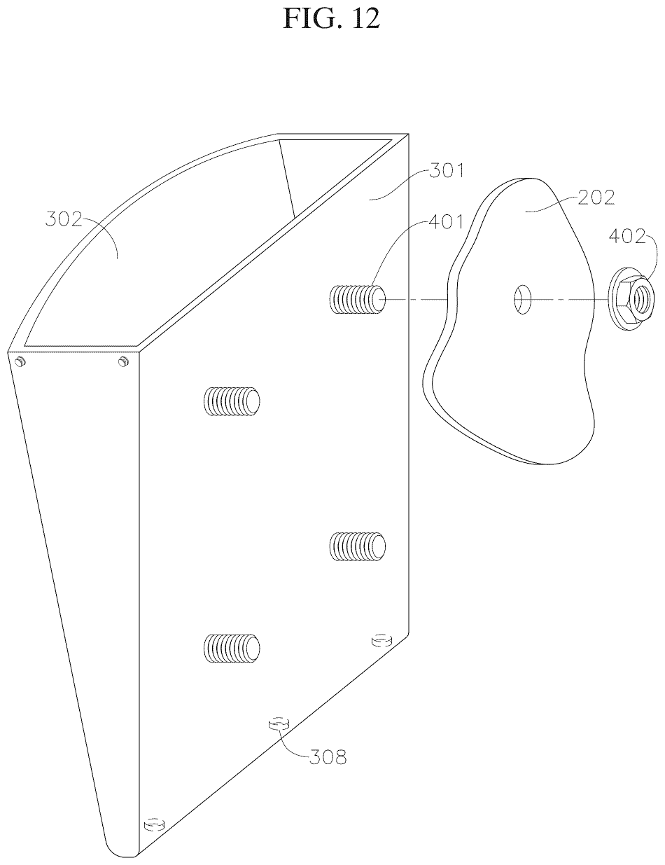

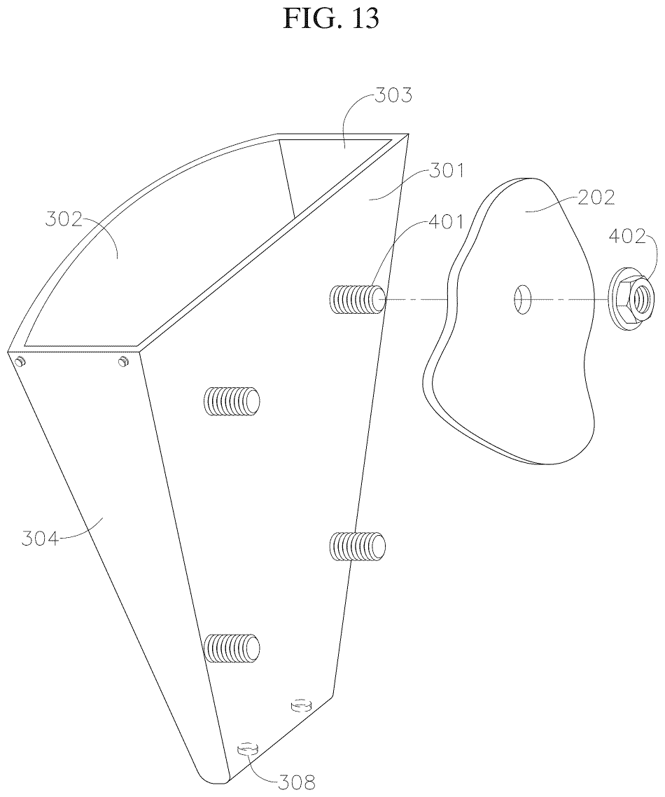

In the illustrated embodiment, the organic waste receptacle 300 is wedge-shaped (e.g., tapered from a wider upper end to a narrower lower end) and includes a front wall 301, a rear wall 302 extending upward from a lower end of the front wall 301, and a pair of sidewalls 303, 304 connecting opposites sides of the front wall 301 to the rear wall 302. Together, the walls 301-304 of the organic waste receptacle 300 define an interior chamber 305 and a mouth 306 in communication with the interior chamber 305. In the illustrated embodiment, the mouth 306 of the organic waste receptacle 300 is flush (e.g., co-planar) with the mouth 208 of the refuse bin 200, although in one or more embodiments the mouth 306 of the organic waste receptacle 300 may not be flush with the mouth 208 of the refuse bin 200 (e.g., the mouth 306 of the organic waste receptacle 300 may be recessed below the mouth 208 of the refuse bin 200). The wedge-shape of the organic waste receptacle 300 is configured to enable the waste (e.g., the green yard waste) inside the refuse bin 200 to slide past the organic waste receptacle 300 during collection by a garbage truck, while also allowing the contents of the organic waste receptacle 300 to be emptied during collection. In one or more embodiments, the rear wall 302 of the organic waste receptacle 300 is flat or substantially flat (i.e., planar or substantially planar). In one or more embodiments, the rear wall 302 of the organic waste receptacle 300 may be curved, as shown in FIGS. 12-13 (e.g., the rear wall 302 of the organic waste receptacle 300 may be curved outward (convex) into the interior compartment 207 of the refuse bin 200 to increase the volume of the interior chamber 305 of the organic waste receptacle 300 compared to an otherwise comparable organic waste receptacle having a flat rear wall). Additionally, in one or more embodiments, the organic waste receptacle 300 may include a double taper. For instance, as illustrated in FIGS. 11 and 13, the organic waste receptacle 300 tapers from a wider and deeper upper end to a narrower and shallower lower end. That is, in the embodiment illustrated in FIGS. 11 and 13, the sidewalls 303, 304 are spaced further apart from each other at the upper end than at the lower end of the organic waste receptacle 300 and the front and rear walls 301, 302 are spaced further apart from each other at the upper end than at the lower end of the organic waste receptacle 300.

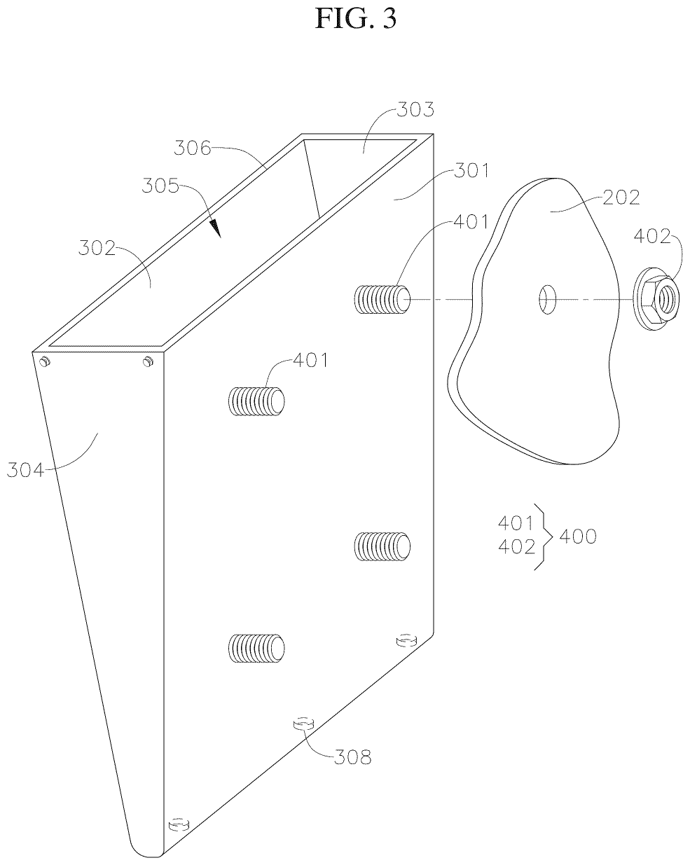

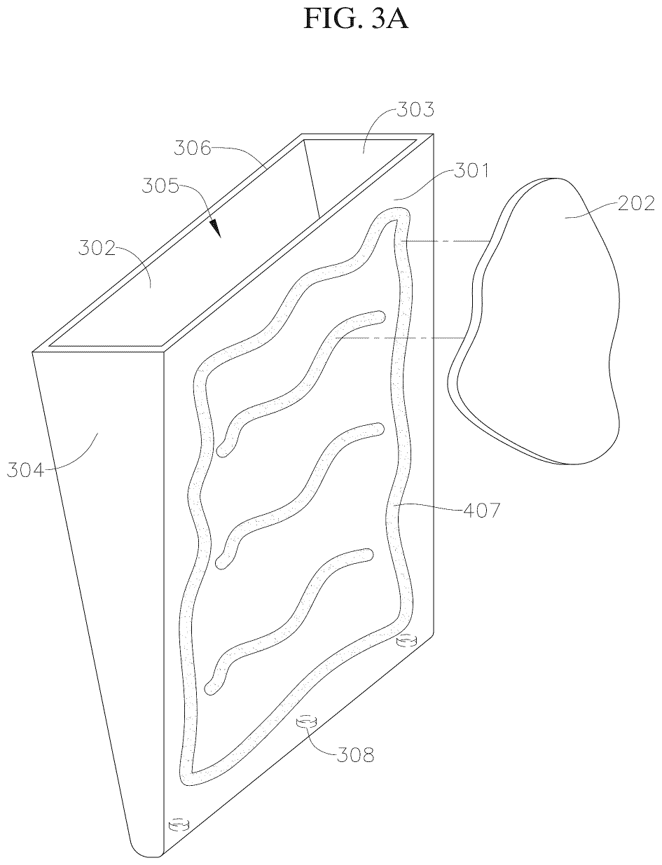

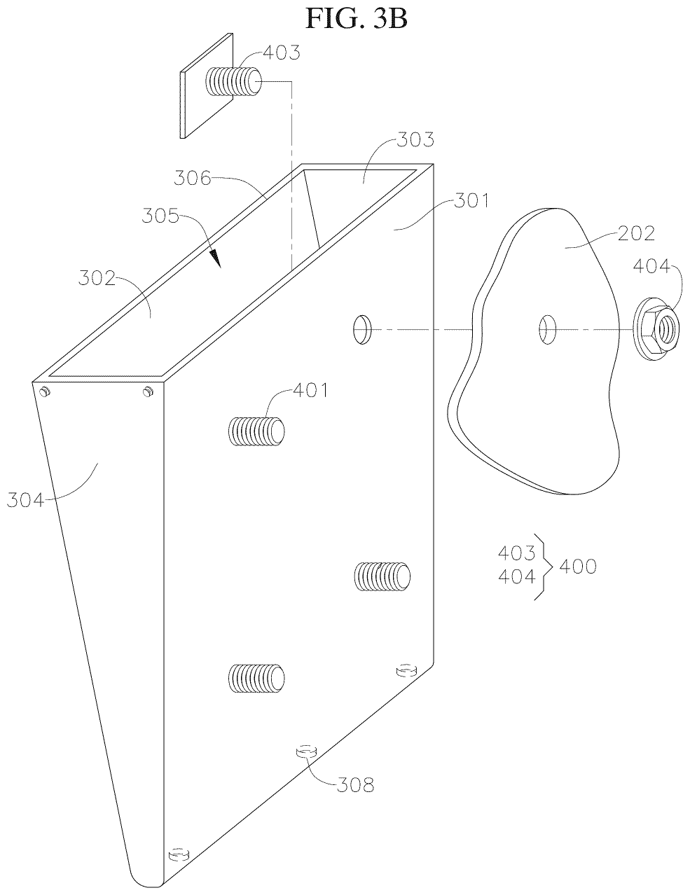

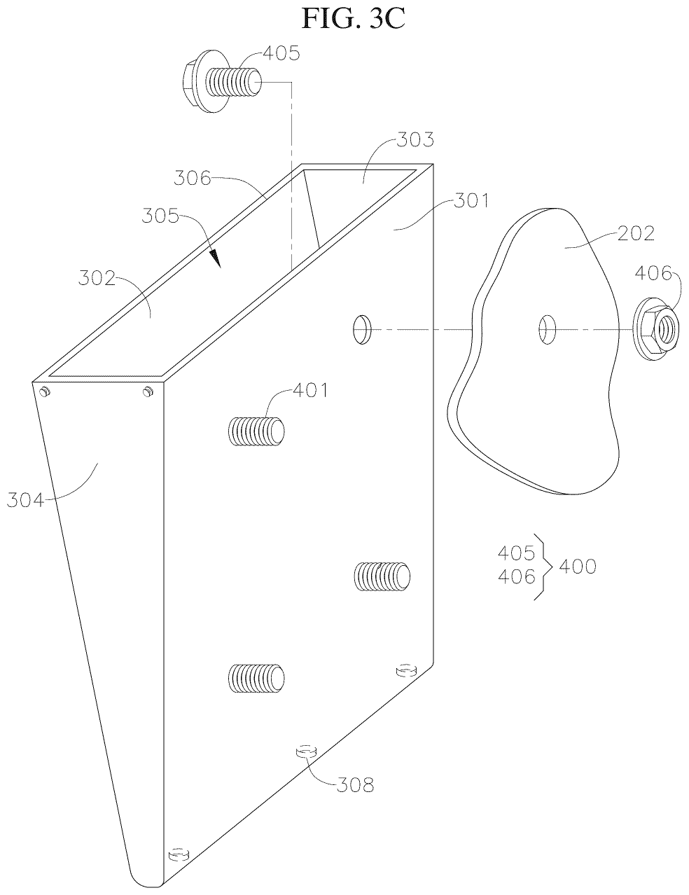

The organic waste receptacle 300 may be coupled to the refuse bin 200 in any suitable manner, such as with fasteners 400 (e.g., threaded studs 401 and nuts 402 as shown in FIG. 3; retaining key-type bolts 403 and nuts 404 as shown in FIG. 3B; or bolts 405 and nuts 406 as shown in FIG. 3C) or with adhesive 407, as shown in FIG. 3A. The fasteners 400 may be metal or non-metal (e.g., nylon and/or plastic). Accordingly, in one or more embodiments, the organic waste receptacle 300 may be fixed to the refuse bin 200 or detachable from the refuse bin 200. Additionally, in one or more embodiments, the organic waste receptacle 300 may be integral with the refuse bin 200, as shown in FIG. 2A (e.g., the organic waste receptacle 300 and the refuse bin 200 may be formed together in an injection molding operation).

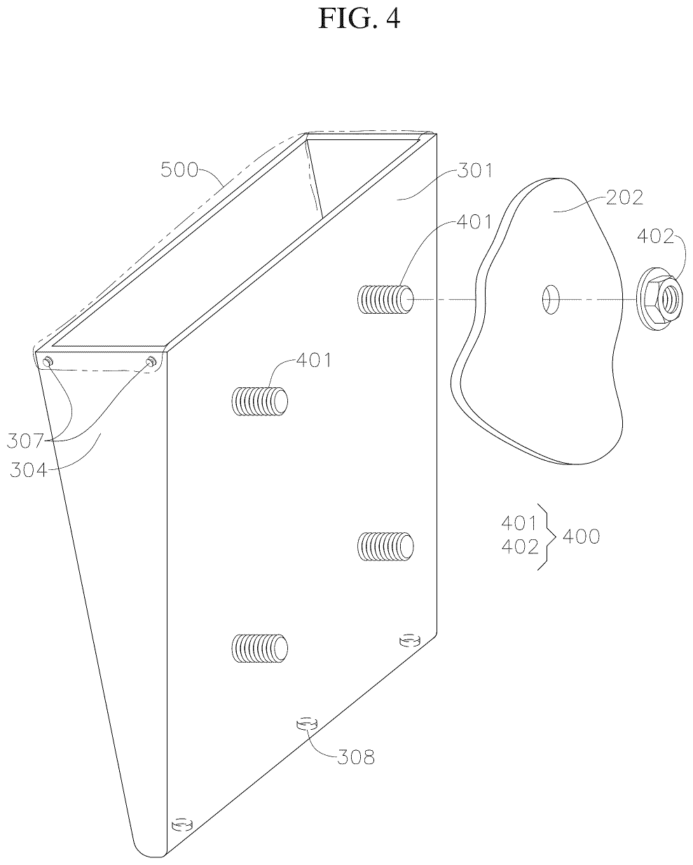

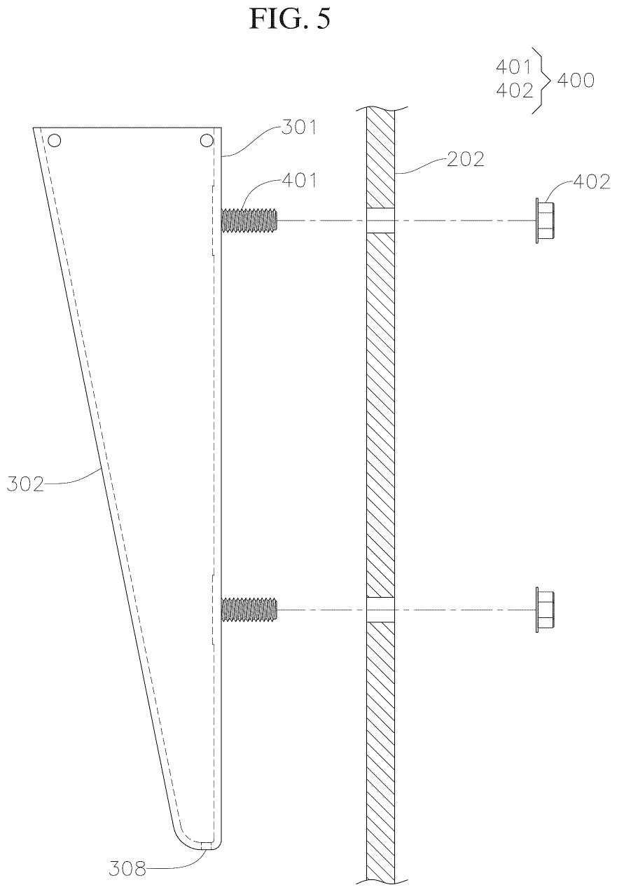

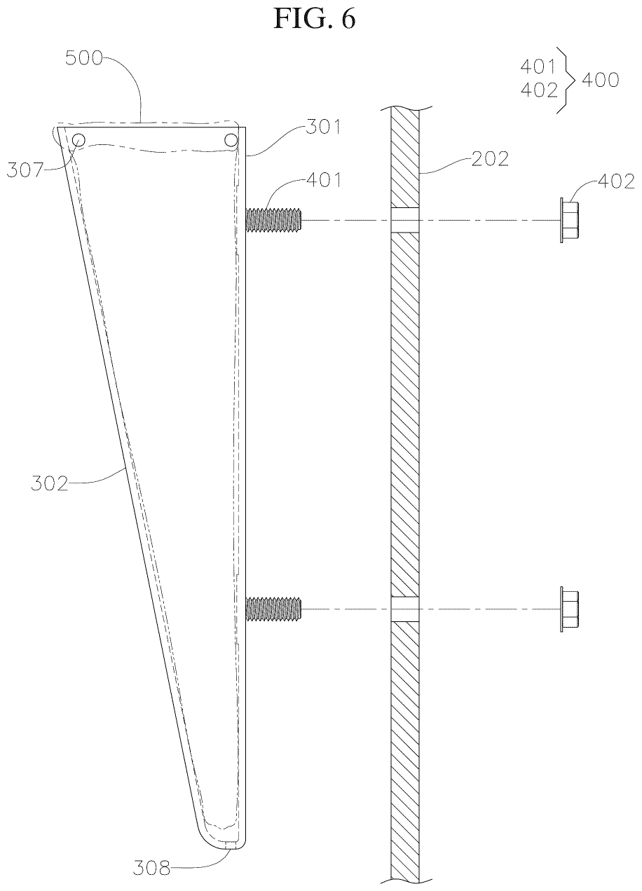

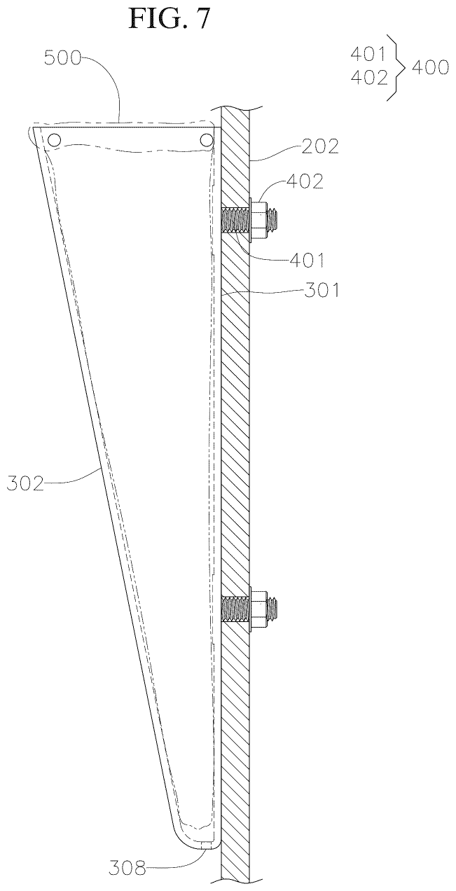

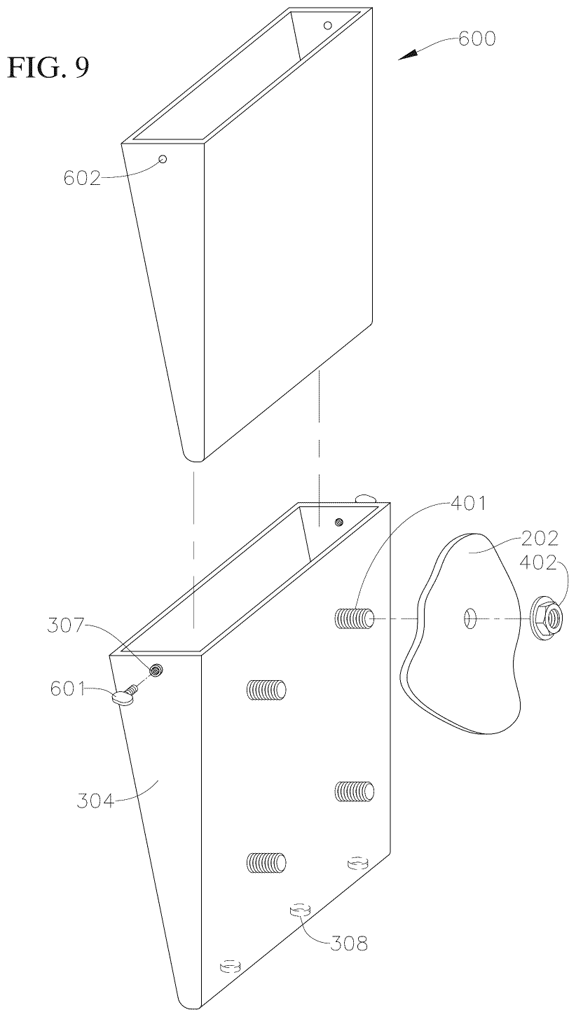

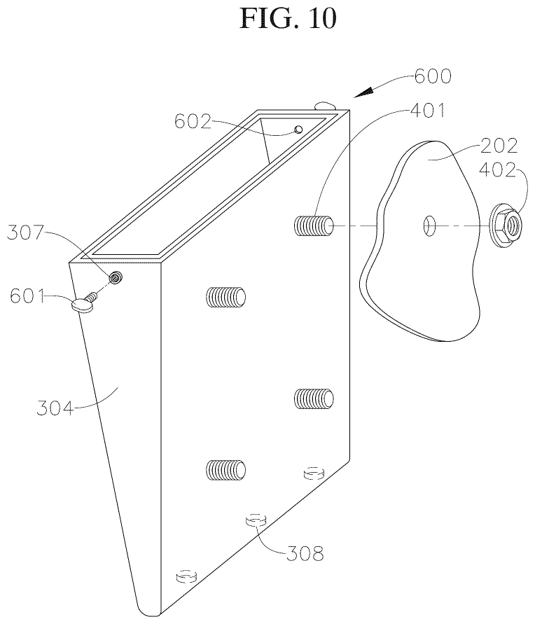

Additionally, in one or more embodiments, the refuse bin assembly 100 may include a liner 500 (e.g., a biodegradable bag) in the interior chamber 305 of the organic waste receptacle 300 (shown in FIGS. 4-7) or a removable insert 600 in the interior chamber 305 of the organic waste receptacle 300 (shown in FIGS. 9-10). The liner 500 (e.g., the biodegradable bag) may be disposed with the organic waste and replaced after every time the trash is collected. The removable insert 600 may be periodically removed from the organic waste receptacle 300, cleaned, and then reinserted into the interior chamber 305 of the organic waste receptacle 300. In this manner, the liner 500 and the insert 600 are configured to protect the organic waste receptacle 300 from becoming dirty and contaminated with organic contaminants, such as bacteria and mold. In one or more embodiments, the liner 500 (e.g., the bag) may be attached to the organic waste receptacle 300 with one or more pins or nubs 307 (e.g., a pair of cylindrical protrusions 307 protruding outward from each of the sidewalls 303, 304 of the organic waste receptacle 300), as shown in FIGS. 4-7. In one or more embodiments, the removable insert 600 may be detachably connected to the organic waste receptacle 300 with one or more fasteners 601 (e.g., thumb screws extending through openings 307, such as threaded openings, in the sidewalls 303, 304 of the organic waste receptacle 300 and into corresponding openings 602 in the removable insert 600), as shown in FIGS. 9-10.

In one or more embodiments, the organic waste receptacle 300 may include one or more drainage holes 308 in a lower portion of the organic waste receptacle 300. The drainage holes are configured to permit liquid organic waste to drain from the organic waste receptacle 300 into the refuse bin 200.

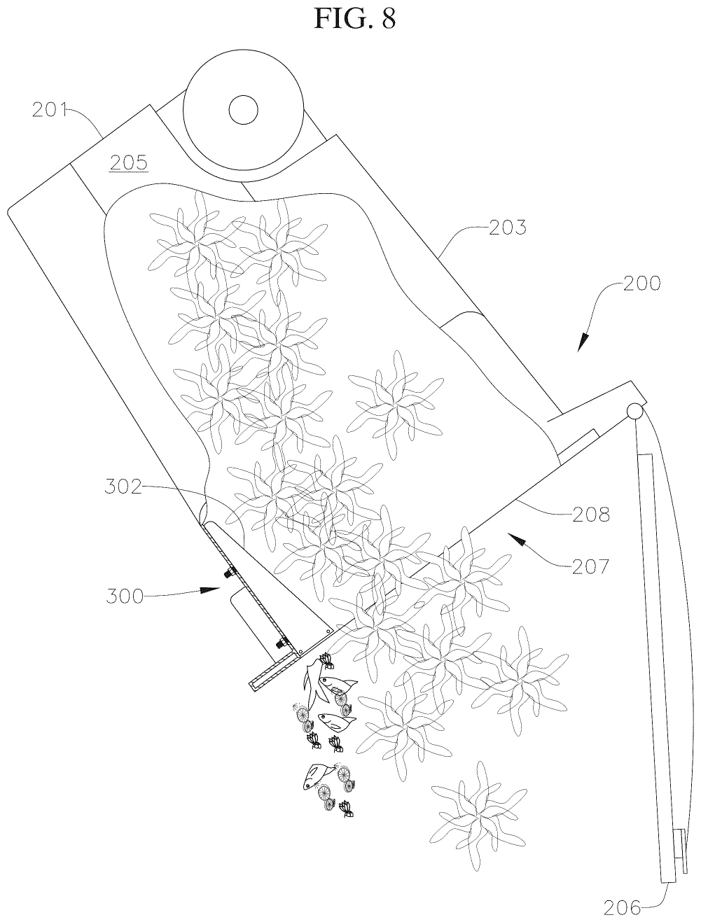

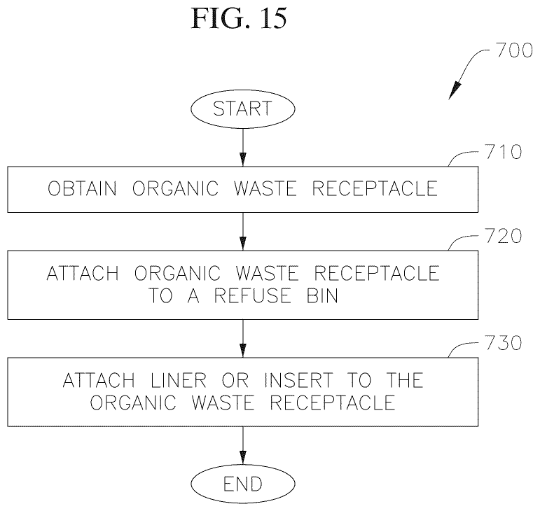

FIG. 15 is a flowchart illustrating tasks of a method 700 of retrofitting a refuse bin to accept organic waste. In one embodiment, the method 700 includes a task 710 of obtaining or providing an organic waste receptacle. The configuration of the organic waste receptacle may be the same as or similar to the configuration of any of the embodiments of the organic waste receptacles depicted in FIGS. 1-13.

In the illustrated embodiment, the method 700 also includes a task 720 of attaching the organic waste receptacle (obtained in task 710) to the interior of a refuse bin. In one or more embodiments, the task 720 may include attaching the organic waste receptacle to a front wall or one of the sidewalls of the refuse bin. Additionally, the task 720 may include detachably connecting the organic waste receptacle to the refuse bin (e.g., with one or more fasteners, such as threaded studs and nuts, bolts and nuts, or retaining key-type bolts and nuts) or fixedly connecting the organic waste receptacle to the refuse bin (e.g., with an adhesive).

In the illustrated embodiment, the method 700 may also include a task 730 of attaching or securing a liner (e.g., a biodegradable bag) or an insert to an interior of the organic waste receptacle, which is configured to protect the organic waste receptacle from becoming dirty and contaminated with organic contaminants, such as bacteria and mold. The task 730 may include attaching the liner to the organic waste receptacle in any suitable manner, such as with one or more pins or nubs (e.g., a pair of cylindrical protrusions protruding outward from each of the sidewalls of the organic waste receptacle). The task 730 may include attaching the insert to the organic waste receptacle in any suitable manner, such as with one or more fasteners (e.g., thumb screws). The task 730 of attaching the liner or the insert to the organic waste receptacle may occur before or after the task 720 of attaching the organic waste receptacle to the interior of a refuse bin.

While the refuse bin assembly, the organic waste receptacle, and the method of retrofitting a refuse bin to accept organic waste have been shown and described with reference to exemplary embodiments thereof, it will be understood by those of ordinary skill in the art that various changes in form and details may be made therein without departing from the spirit and scope of the present invention as defined by the following claims.

What is claimed is:

1. A refuse bin assembly comprising:
a refuse bin comprising:
a base;
at least one wall extending upward from the base;
an interior compartment defined by the base and the at least one wall;
a mouth at an upper portion of the at least one wall, the mouth being in communication with the interior compartment; and
a lid hingedly coupled to the at least one wall; and
an organic waste receptacle in the interior compartment of the refuse bin.

2. The refuse bin assembly of claim 1, wherein:
the at least one wall comprises a plurality of walls,
the lid is hingedly coupled to a rear wall of the plurality of walls, and
the organic waste receptacle is coupled to a front wall of the plurality of walls opposite to the rear wall.

3. The refuse bin assembly of claim 1, wherein the at least one wall comprises a plurality of walls, and wherein the organic waste receptacle is coupled to one of two sidewalls of the plurality of walls.

4. The refuse bin assembly of claim 1, wherein the organic waste receptacle is wedge-shaped and tapers from a wider upper end to a narrower lower end.

5. The refuse bin assembly of claim 1, further comprising a biodegradable liner in the organic waste receptacle.

6. The refuse bin assembly of claim 1, further comprising a removable insert in the organic waste receptacle.

7. The refuse bin assembly of claim 1, wherein the organic waste receptacle comprises at least one drainage hole.

8. The refuse bin assembly of claim 1, wherein the organic waste receptacle is detachable from the refuse bin.

9. The refuse bin assembly of claim 1, wherein the organic waste receptacle is integral with the refuse bin.

10. The refuse bin assembly of claim 1, wherein an opening of the organic waste receptacle is substantially flush with the mouth of the refuse bin.

11. The refuse bin assembly of claim 1, wherein an opening of the organic waste receptacle is recessed below the mouth of the refuse bin.

12. The refuse bin assembly of claim 1, wherein the organic waste receptacle is coupled to the refuse bin with a plurality of fasteners.

13. The refuse bin assembly of claim 1, wherein the organic waste receptacle is coupled to the refuse bin with an adhesive.

14. The refuse bin assembly of claim 1, wherein a rear wall of the organic waste receptacle is substantially flat.

15. The refuse bin assembly of claim 1, wherein a rear wall of the organic waste receptacle is convex.

16. A method of retrofitting a refuse bin to accept organic waste, the method comprising:
securing an organic waste receptacle in an interior of the refuse bin.

17. The method of claim 16, wherein the securing comprises fastening the organic waste receptacle to the interior of the refuse bin with a plurality of fasteners.

18. The method of claim 16, wherein the securing comprises adhering the organic waste receptacle to the interior of the refuse bin with an adhesive.

19. The method of claim 16, further comprising installing a liner in the organic waste receptacle.

20. The method of claim 16, further comprising installing an insert in the organic waste receptacle.
